(19) United States
(12) Patent Application Publication
(10) Pub. No.: US 2001/0034946 A1
(43) Pub. Date: Nov. 1, 2001

(54) Leveling tool

(76) Inventor: Duane Hamdorf, Robbinsdale, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/820,222

(22) Filed: Mar. 28, 2001

Related U.S. Application Data
(60) Provisional application No. 60/192,710, filed on Mar. 28, 2000.

(51) Int. Cl. G01C 9/00; B43L 7/00

(52) U.S. Cl. 33/451; 33/518; 33/527

(57) ABSTRACT

A leveling tool including a screed bar and a scraper blade. The screed bar includes either a slot or a bracket to slightingly accommodate the scraper blade. These grape or blade is vertically adjusted within the slot or bracket to a desired height and may be fixed at the desired height by inserting bolts through aligned holes. Once the leveling tool has been adjusted to a desired height, the soil surface proximate the land escaping block can be planed or leveled at an elevation to enable a second block to be placed next to the first block, the tops of the blocks being level.

### CLAIM TO PRIORITY

The present application claims priority to United States provisional patent application No. 60/192,710, filed Mar. 28, 2000, and entitled “Leveling Tool.” The identified provisional patent application is hereby incorporated by reference.

### FIELD OF THE INVENTION

The present invention relates to landscape tools and, more particularly, to landscape tools which may be used during the installation of concrete retaining wall blocks and pavers for leveling the surface upon which the first layer of blocks is placed.

### BACKGROUND OF THE INVENTION

Landscape blocks are used to create functional and esthetic structures such as retaining walls, walk ways, and flower beds. When installing landscape block, the first row (or tier) must be laid atop soil. To ensure a wall with an even height and satisfactory stability, it is important that the soil upon which the block is to be laid is even and level. Leveling is usually done with a shovel and is then visually examined for level and evenness at each step in erecting a structure with landscape blocks. In most instances, an installer attempts to level the soil and place the first block. The second block is then placed proximate the first block and “eyed-up” and/or measured with a level to ensure that the second block is level (hence even) with the first block. Most often, an even height is not achieved on the first attempt. If an even height is not achieved, the installer must remove the second block to attempt to level the soil once again, using hands, shovel, rake, etc. After the second attempt at leveling the soil, the second block is replaced to again determine whether the second block is even in height with the first. This potentially iterative process may occur numerous times, thereby undesirably lengthening the installation process and making the job more strenuous for the installer, e.g., multiple liftings of the same block.

As such, there is a need for a tool that may be used to level the surface upon which a first layer of retaining wall block is placed. This tool should be easy to use and should significantly reduce the installation time and strain placed on the installer.

### SUMMARY OF THE INVENTION

The needs described above are in large measure met by a leveling tool of the present invention. The leveling tool generally comprises a screed bar and a scraper blade. The scraper blade is insertable through a slot in the screed bar and is securable to the screed bar at various adjustable, possibly standard heights, e.g., the scraper blade may be adjusted to a height to accommodate a 4-inch, 6-inch, 8-inch, or 8.5-inch block. It should be note that block sizes are now varying to metric dimensions and the leveling tool can be adjusted to new sizes by drilling appropriately placed holes in the scraper blade. The screed bar may further include a level.

Both the screed bar and scraper blade are preferably made of aluminum. However, other materials may be used such as wood, molded plastics, Plexiglass®, etc.

There is provided a leveling tool, the leveling tool enabling blocks to be placed on planed soil, such that the tops of the blocks are substantially level and such that the blocks will form a stable base for other tiers placed atop the base when constructing structures such as retaining walls. The leveling tool may include a substantially planar scraper blade and a screed bar. The screed bar may display a bottom surface and adjusting structure slidingly accommodating a horizontal cross section of the scraper blade therein. The adjusting structure may include a slot disposed in the screed bar. Alternatively, the adjusting structure may include a bracket fixed to a side of the screed bar. A level may be attachably or integrally present on the screed bar.

There is further provided a process of laying a plurality of blocks on a soil surface using a leveling tool. The leveling tool may include a scraper blade and a screed bar. The screed bar may include an adjusting structure, the adjusting structure slidingly accommodating a horizontal cross section of the scraper blade. The process may include 1) disposing a first of a plurality of blocks on the soil surface; 2) vertically adjusting the scraper blade within the screed bar adjusting structure to a desired vertical distance between a scraper blade lower edge and the screed bar lower surface (e.g., to the height of the first block); 3) contacting the screed bar bottom surface with the first block upper surface; and 4) planing the soil adjacent the first block with a scraper blade while sliding the screed bar on the first block upper surface.

These and other objects, features, and advantages of this invention will become apparent from the description which follows, when considered in view of the accompanying drawings.

### BRIEF DESCRIPTION OF THE DRAWINGS

FIG. 1 is a front, perspective view of one embodiment of the present leveling tool;

FIG. 2 is a front, perspective view of the present scraper blade;

FIG. 3 is a side view of the embodiment of FIG. 1, along lines 3-3;

FIG. 4 is a top view of the embodiment of FIG. 1, along the lines 4-4;

FIG. 5 is a top view of the present leveling tool being used to level soil in preparation for laying a landscape block; and

FIG. 6 is a side view of the present leveling tool being used to level soil in preparation for laying a land escape block.

### DESCRIPTION OF THE PREFERRED EMBODIMENTS

Any references to such relative terms, such as front and back, right and left, top and bottom, upper and lower, horizontal and vertical, are intended for convenience of description and are not intended to limit the present invention or its components to any one positional or spatial orientation. All dimensions of the components in the attached figures may vary with a potential design and the intended use of an embodiment of the invention without departing from the scope of the invention.

Tool Components

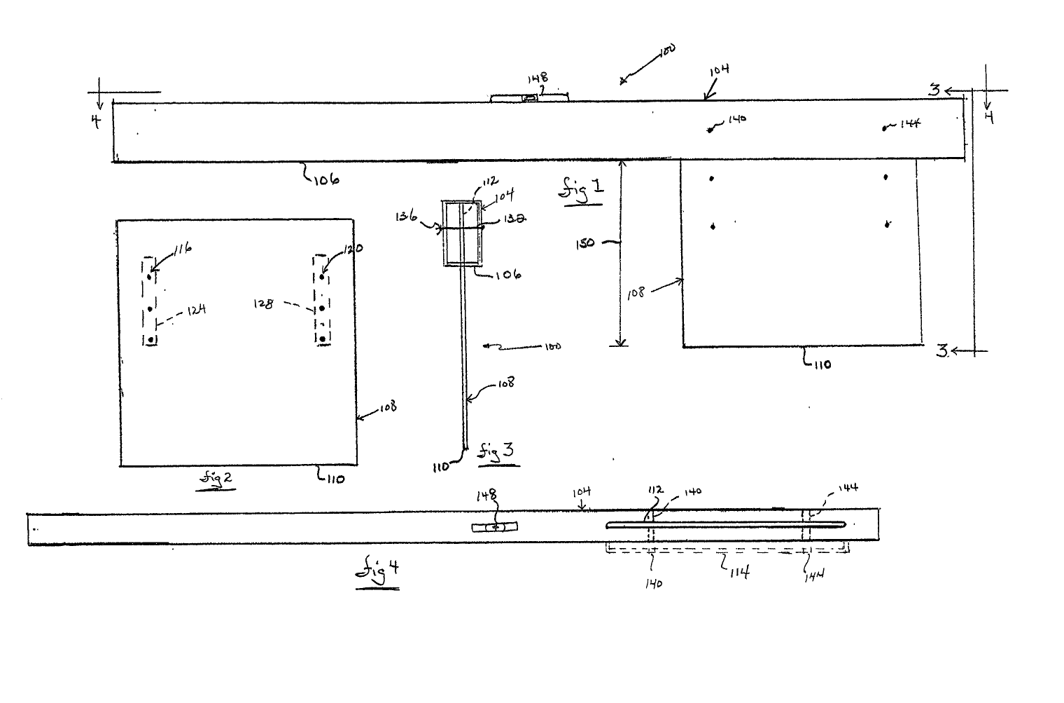

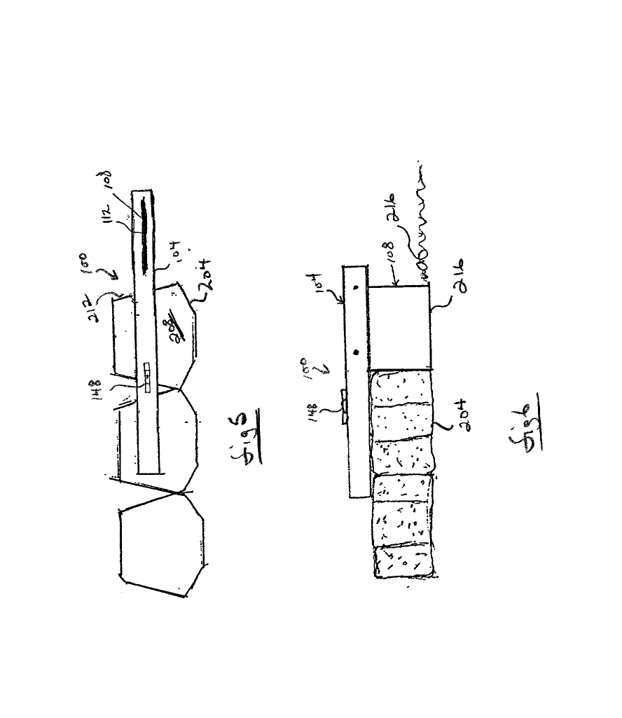

The leveling tool 100 of the present invention, see FIGS. 1-4, generally comprises a screed bar 104 with a lower surface 106 and a scraper blade 108 with a lower scraping (planing) edge 110. The screed bar 104 includes adjusting structure, such as a slot 112 or a bracket 114 (shown in phantom in FIG. 4). A horizontal cross section of the scraper blade 108 (as indicated in FIG. 1) may be accommodated in the slot 112 or bracket 114. The bracket 114 may be mounted on the side of the screed bar 104. In one embodiment, the scraper blade 108 is provided with a plurality of, (e.g., two) columns 116 and 120 of holes, allowing it to be height adjustable to accommodate various block heights. Alternatively, slots 124 and 128 may be present in lieu of the columns of holes 116, and 120. The slots 124 and 128 would allow for a continuous height adjustment, rather than the discrete distances accommodated by the present of the hole columns 116 and 120. Once inserted through the slot 112 in the screed bar 104 (or the bracket 114), the scraper blade 108 may be attached to the screed bar 104 through the use of fasteners, such as bolts 132 and wing nuts 136 (or pins), wherein the bolts 132 are inserted through the holes 116 and 120 in the scraper blade 108 and corresponding holes 140 and 144 in the screed bar 104 (or bracket 114). The present screed bar may incorporate a level 148 that is positioned atop (or attachable to) the screed bar 104 or integrally (or unitarily) incorporated into the screed bar 104. Both the screed bar 104 and scraper blade 108 may be fabricated from aluminum, however, other materials, e.g., molded plastics, wood, Plexiglas®, etc., may be used without departing from the spirit or scope of the invention. One suitable screed bar is made from 3/16″×¼″×2 ½″ tube aluminum. A suitable scraper blade may be made from 3/16″×10″ sheet aluminum.

In one embodiment, one suitable screed bar has a length of about 36 inches, a thickness of about 1 ¼ inch, and a height of about 2 ½ inches. The screed bar slot may be about 10 inches long and ¼ inch wide. One suitable scraper blade is about 10 inches wide, 10 7/16 inches high and 3/16 inch thick. The top holes in the scraper blade may be spaced about 1 ¼ inch from the upper edge thereof. The remaining holds may be spaced apart at a distance of about 2 inches. This arbitrary spacing would configure the present leveling tool for standard landscape block heights, e.g., 4″, 6″, 8″, and 10″. The holes present in the screed bar and scraper blade may be about ¼ inch in diameter.

Instructions for Use

Referring particularly to FIGS. 5 and 6, after one retaining wall block 204 is installed to the proper height, the installer is ready to use the leveling tool of the present invention. First, the height of the scraper blade is adjusted to correspond to the height of the block that is being worked with. Stated otherwise, the scraper blade is vertically adjusted so that a vertical distance 150 between the screed bar lower surface 106 and the scraper blade lower edge 110 is substantially equal to a height of the block. The height of the scraper block 108 is adjusted by aligning holes in columns 116 and 118 with respective holes 104 and 144 in the screed bar 104.

Next, the screed bar 104 is set on top 208 of the first block 204 with the scraper blade 108 hanging just past the edge 212 of the first block. The leveling tool 100 is then pulled forward and/or pushed backward with one hand while the installer's other hand maintains (slides) the screed bar 104 firmly against the top 208 of the first block 204. As the leveling tool 100 is pulled along, the soil surface 216 beneath the scraper blade is flattened out (planed) to the proper, level height. If not enough soil is present beneath the scraper blade, soil may be added and tamped, then the process is repeated. Once the soil has been planed and adjusted to the proper height, the next retaining block may be laid atop the newly leveled soil. The process is then repeated for as many base blocks as desired. The term “soil” is intended to encompass soil (dirt), sand, gravel, aggregate or any planable and/or generally granular substance used as a base for a structure (wall) as described herein.

Overall, by using the leveling tool of the present invention, the time needed to install the retaining wall base block is greatly reduced. Further, the block is installed more accurately positioned and the numerous repositionings of a single block are greatly reduced or entirely eliminated. The present leveling tool is of a straight-forward design that is easy to use allowing homeowners as well as contractors to install a retaining wall with accuracy and speed. The process of installing the wall is also less strenuous and repetitious for the installer by using the leveling tool.

As an alternative embodiment of the present invention, the described scraper blade 108 may be used alone, without the screed bar 104, however, the accuracy of the placement of blocks is diminished. Still another alternative embodiment of the present invention comprises securing the scraper blade 108 to a pre-existing standard level, e.g., a 4-foot level. The scraper blade 108 may utilizes holes 116 and 120, with corresponding holes in the level, for securement to the level with bolts, or, alternatively, the scraper blade 108 may simply be clamped to the pre-existing standard level.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A leveling tool, comprising:
a substantially planar scraper blade with a bottom edge; and
a screed bar with a bottom surface and adjusting structure, the adjusting structure slidingly accommodating a horizontal cross section of the scraper therein.

2. The leveling tool of claim 1, the adjusting structure accommodating the scraper blade such that the scraper blade is substantially perpendicularly disposed with respect to the screed bar.

3. The leveling tool of claim 1, the adjusting structure comprising a slot disposed in the screed bar.

4. The leveling tool of claim 1, the adjusting structure comprising a bracket fixed to a side of the screed bar.

5. The leveling tool of claim 1, the scraper blade defining first and second columns of holes, the adjusting structure comprising a slot disposed in the screed bar and a first and second hole transversely intersecting the slot, each screed bar first and second hole aligning with a one of the respective scraper blade first and second columns of holes.

6. The leveling tool of claim 1, the scraper blade defining first and second columns of holes, the adjusting structure comprising a bracket with a first and a second hole defined therein, the bracket fixed to a side of the screed bar, the first and bracket holes aligning with respective scraper blade first and second columns of holes.

7. The leveling tool of claim 1, in which the scraper blade defines first and second columns of scraper blade holes and in which the screed bar defines a first and second screed bar holes, each screed bar hole aligning with one of the first and second columns of holes, further comprising a fastener, the fastener disposable in the aligned screed bar and scraper blade holes.

8. The leveling tool of claim 7, the faster comprising a bolt and a nut.

9. The leveling tool of claim 8, in which the nut is a wing nut.

10. The leveling tool of claim 1, in which a plurality of slots is defined in the scraper blade.

11. The leveling tool of claim 1, further comprising a level attachable to the screed bar.

12. The leveling tool of claim 1, further comprising a level, the level integral to the screed bar.

13. A process for laying a plurality of blocks on a soil surface using a leveling tool, each block with an upper surface and a block height, the leveling tool comprising a scraper blade with a lower edge and a screed bar with a bottom surface, the screed bar comprising an adjusting structure slidingly accommodating a horizontal cross section of the scraper blade therein, the process comprising:
disposing a first of the plurality of blocks on the soil surface:
vertically adjusting the scraper blade within the screed bar adjusting structure to a desired vertical distance between a scraper blade lower edge and the screed bar lower surface;
contacting the screed bar lower surface with the first block upper surface; and
planing the soil adjacent the first block with the scraper while sliding the screed bar on the first block upper surface, thereby defining a planed soil surface.

14. The process of claim 13, in which the scraper blade is vertically adjusted such that the vertical distance is substantially equal to the first block height.

15. The process of claim 13, in which the scraper blade defines a scraper blade hole and the screed bar defines a screed bar hole, further comprising disposing a fastener in the aligned scraper blade hole and screed bar hole when the scraper blade is vertically adjusted.

16. The process of claim 13, in which the scraper blade defines a scraper blade hole and the screed bar defines a screed bar hole, further comprising disposing a bolt in the aligned scraper bolt hole and screed bar hole when the scraper blade is vertically adjusted.

17. The process of claim 13, further comprising placing a second of the plurality of blocks on the planed soil surface proximate the first of the plurality of blocks.

18. The process of claim 13, in which the scraper blade defines a generally vertical scraper blade column and the screed bar defines a screed bar hole, further comprising disposing a bolt in the aligned scraper blade column and screed bar hole.

19. The process of claim 18, further comprising threadably tightening a nut on the disposed bolt.

20. The process of claim 13, in which planing the soil adjacent the first block includes observing a level, the level attached to the screed bar.

21. The process of claim 13, in which planing the soil adjacent the first block includes observing a level, the level integral to the screed bar.

22. A process of making a leveling tool, comprising:
forming a scraper blade; and
forming a screed bar with adjusting structure slidingly accommodating a horizontal cross section of the scraper blade.

23. The process of claim 22, in which forming a screed bar with adjusting structure comprises disposing a slot in the screed bar.

24. The process of claim 22, in which forming a screed bar with adjusting structure comprises fixing a bracket to a side of the screed bar.

25. The process of claim 22, in which forming a scraper blade comprises disposing a plurality of the generally vertically aligned hole columns in the scraper blade.

26. The process of claim 22, in which forming a scraper blade comprises forming a plurality of slots in the scraper blade.

27. The process of claim 22, in which forming a screed bar comprises forming a plurality of holes extending through the screed bar adjusting structure.

28. The process of claim 22, further comprising providing a level, the level attachable to the screed bar.

29. The process of claim 22, in which forming the screed bar comprises attaching a level to the screed bar.
